(19) United States
(12) Patent Application Publication
(10) Pub. No.: US 2014/0373938 A1
(43) Pub. Date: Dec. 25, 2014

(54) Liquid Supply System

(71) Applicant: Jaidip Shah, Mumbai (IN)

(72) Inventor: Jaidip Shah, Mumbai (IN)

(21) Appl. No.: 13/879,626

(22) PCT Filed: Oct. 25, 2011
(86) PCT No.: PCT/IN2011/000742

§ 371 Date: Sep. 3, 2014

(30) Foreign Application Priority Data
Oct. 27, 2010 (IN) 2990/MUM/2010

(51) Int. Cl. F17D 1/20; E03B 5/02; E03B 11/02

(52) U.S. Cl. CPC F17D 1/20; E03B 11/02; E03B 5/02
USPC 137/206

(57) ABSTRACT

A liquid supply system comprising of a source of liquid, at least one storage (325,326,312) at an elevation, supply pipe line (305) connecting the source of liquid to the said storage, a device to raise/move the liquid from the said source to the said storage, at least one outlet (370, 380) at or below the level of said storage; wherein the said storage is hermetically closed and is capable of holding the liquid under air pressure. The delivery pipeline is connected to the various outlets to supply pressurized liquid to the user after opening of the outlet (s) at any time including the period when the pump is not supplying to the closed storage facility. A one way valve (314) connected to the closed facility is activated by building up of liquid in the intermediary buffer line which creates a low pressure which forces the one way valve to open when the pressure in the system falls below atmospheric pressure.

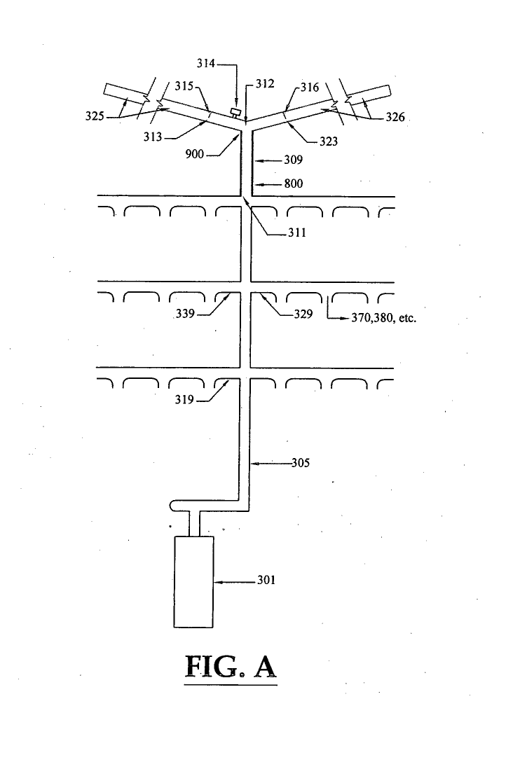

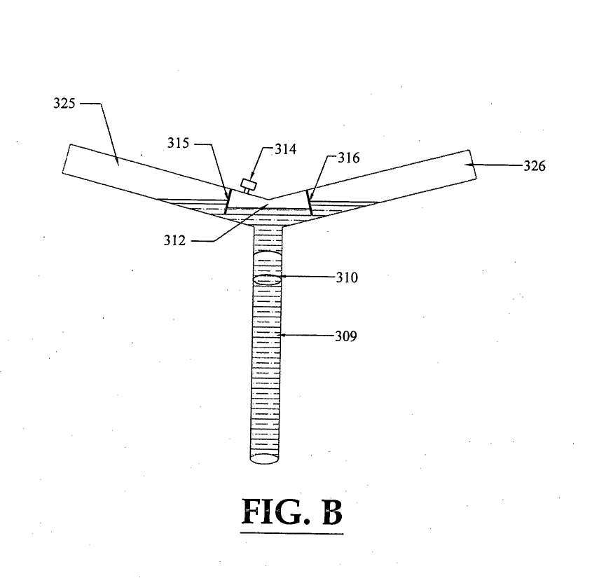

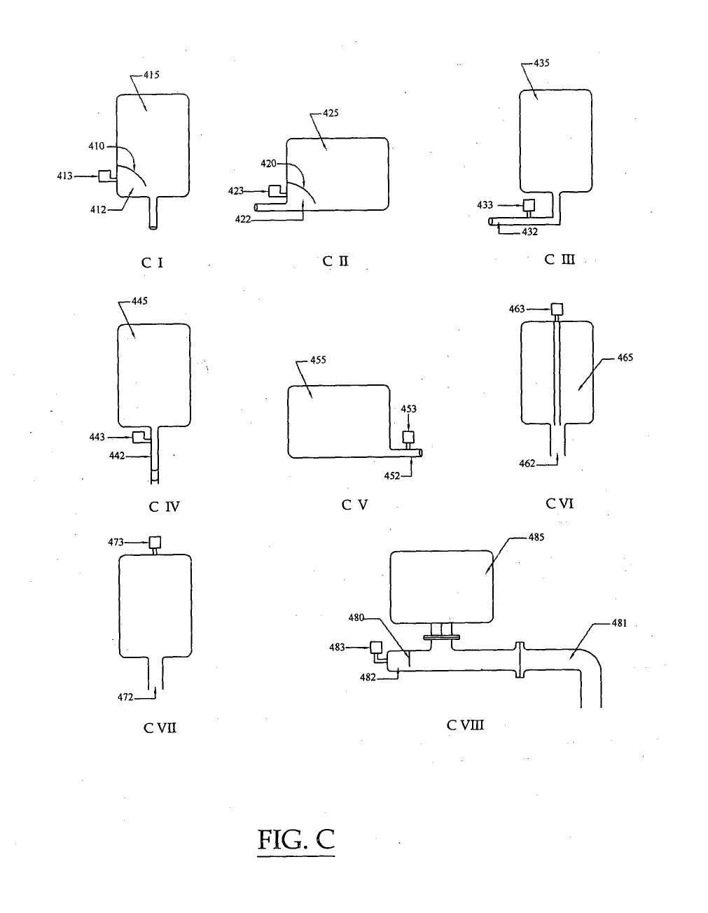

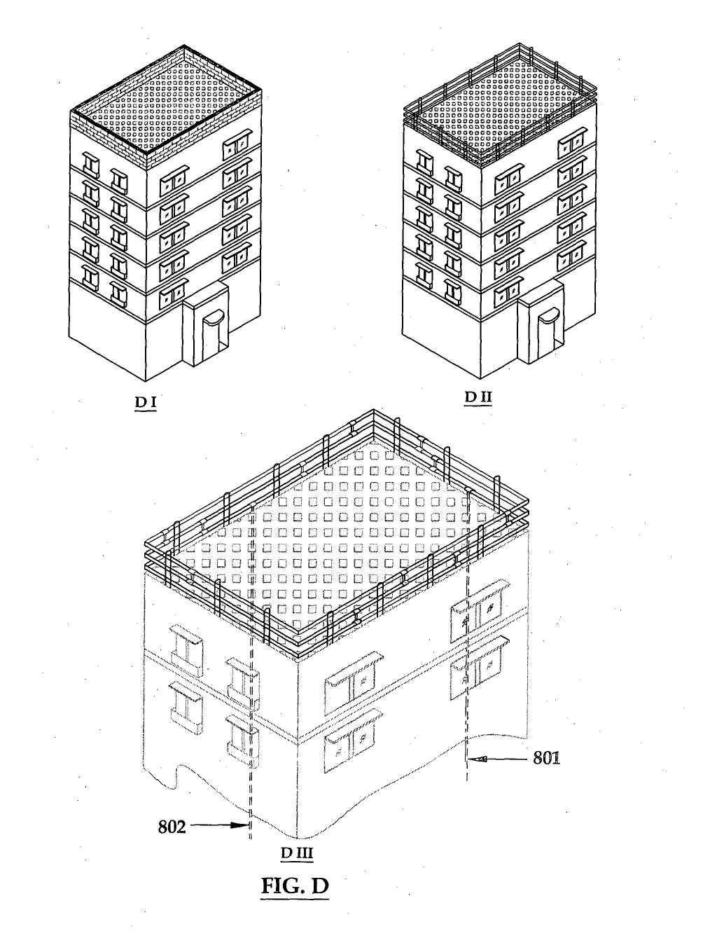

### FIELD OF INVENTION

This invention relates to a liquid supply system for controlled and uninterrupted liquid supply (such as but not limited to water) comprising source of liquid, one or more device to raise the liquid, supplying liquid to the hermetically closed storage.

### PRIOR ART

In residential complexes overhead tanks are used which then supply water to the individual users. Similar storage arrangements are made in several other places of liquid usage.

As per the requirement, hydro pneumatic systems are used in ships, multi storey buildings, etc. A typical hydro pneumatic system comprises of the water supply source, pump(s), the air/liquid pressure tank an the system demand. The plumbing, foot valves, gate valves, pressure gauges and other fittings are provided as required. In short the tank(s) act as a storage facility to ensure supply of pressurized liquid to the delivery line for a limited time, even when pump(s) are not running. To maximize the utility volume (liquid volume), the tank is pre-pressurized by compressed air or fitted with a diaphragm to separate the air from liquid. Compressors are also needed to replenish the air loss which happens during the operation. In diaphragm tanks, the tanks need to be pressurized regularly.

The diaphragm tank operates on the principle that, while air is compressible, liquid is not. Before pump starts up, the upper portion of tank is pre-charged with air at a pressure that is slightly below pump cutting in pressure. This pre-charged presses the diaphragm against the bottom of the tank and thus occupies a substantial volume of the tank. The first time the pump starts; water is pumped into the bottom of the tank forcing the diaphragm upward and compresses the air above.

When the pump shuts off the air pressure above the diaphragm has been compressed to a pressure equal to the water pressure below the diaphragm. When a fixture is opened the compressed air above the diaphragm will expand, forcing liquid out of the system under pressure. This delivery, without assistance from the pump is referred to as drawdown. When the liquid pressure in the tank decreases to pump cut in pressure, the pump will restart and the full cycle will begin again. Since the tank recharge is lower than the pump cut in pressure, the tank is never entirely drained. This allows an uninterrupted flow of water throughout the delivery cycle.

In non diaphragm tanks, air has a tendency to dissolve in the liquid. This reduces the system operating efficiency, requiring more frequent starts/stops of the pump. The air is replenished by various ways; one of the most common methods is use of an air compressor.

Some of the problems with hydro pneumatic stations are that while they provide adequate pressure, they provide limited volume. In some instances, with the non bladder pressure vessels, air may be forced into the liquid lines if the demand for water exceeds pump capacity. Also, if the air space in the vessel is lost due to leakage (liquid logging), the pressure pump will start frequently, resulting in erratic pressure, lower power efficiency and low liquid volume. Also, pressure will not last long during power outages.

U.S. Pat. No. 5,190,443 describes a hydro pneumatic constant pressure device for automatically controlling pump having flow sensor for detecting variation in demand including driving cylinder cooperating with sensor piston under fluid pressure to transfer the liquid. As per this arrangement the pump is activated by pressure decrease due to supply of liquid and deactivate it upon pressure increase due to stoppage of flow.

The present invention is arranged to provide instant flow under pressure from its storage facility, upon decrease of pressure in the delivery line, without directly activating the pump. Increase of pressure [when the pumps are running] upon stoppage of outflow will refill the storage facility.

US publication no. 2009/0255595 describes an Apparatus and method for introducing air into a Hydro Pneumatic Reservoir. The said patent document has enumerated introduction of air by use of a-valve controlled by mechanical/electrical means, which is in turn controlled by a pressure sensing device. This valve allows air entry when pumps are off, but pressurized liquid of the pipeline returns back, thereby power is wasted to that extent. Initially tank may have to be pre pressurized in case system pressure is too high. There may be air leakages at the vacuum relief valve in the pipeline. A tank is also an essential feature and all delivery points have to be necessarily beyond the tank. The possibility of using foot valve has been ruled out. Stopping of the pump leads to instant back pressure, resulting in fluctuation of pressure inside the system. The system is not too efficient if the system static pressure is too high.

### OBJECT OF THE INVENTION

One of the objects of the present invention is to improve overall efficiency of the system. Higher volume efficiency and so higher energy storage. Lower number, of starts and stops, efficient use of the assets, aggregates and to reduce overall costs.

Another object of the present invention to reduce pressure in the stored facility and to reduce structural load of the building

Yet another object of the present invention to tolerate entry of foreign particles inside the system, subject to the pumps' ability.

### BRIEF SUMMARY OF THE INVENTION

A liquid supply system comprising of a source of liquid, at least one storage at an elevation, supply pipe line connecting the source of liquid to the said storage, a device to raise/move the liquid from the said source to the said storage, at least one outlet at or below the level of said storage; wherein the said storage is hermetically closed and is capable of holding the liquid under air pressure.

The delivery pipeline is connected to the various outlets to supply pressurized liquid to the user after opening of the outlet(s) at any time including the period when the pump is not supplying to the closed storage facility.

A one way valve connected to the closed facility is activated by building up of liquid in the intermediary buffer line which creates a low pressure which forces the one way valve to open when the pressure in the system falls below atmospheric pressure

### BRIEF DESCRIPTION OF THE DRAWINGS

The invention will now be described, with reference to the accompanying drawings wherein same numerals are used to denote the same parts. However, the drawings only illustrate the invention and in no way limit the invention.

In the accompanying drawings:

FIG A: shows the schematic view of an arrangement of an improved liquid supply system.

FIG. B: shows of an improved liquid supply system above the intermediately buffer line (309).

FIG C (I-VIII): Shows the schematic view of various embodiments of storage facility and position of the valve.

FIG D (I to III): shows arrangement of storage facility by a network of pipeline on a building.

### DESCRIPTION OF THE INVENTION

A liquid supply system comprising of a source of liquid, at least one storage at an elevation, supply pipe line connecting the source of liquid to the said storage, a device to raise/move the liquid from the said source to the said storage, at least one outlet at or below the level of said storage; wherein the said storage is hermetically closed and is capable of holding the liquid under air pressure.

As per one of the embodiment, a liquid supply system a hermetically closed storage with a vacuum relief value allowing atmospheric air to enter into the said hermetically closed storage when the pressure inside the said storage falls below the atmospheric pressure.

As per one of the embodiment, a liquid supply system is provided with a vacuum relief value near the entry point of the hermetically closed storage.

As per one of the embodiment, a liquid supply system is provided with a vertical liquid column between the said supply pipe line and the said hermetically closed storage.

As per one of the embodiment, liquid supply system is provided with a valve which is actuated by electrical, mechanical or pneumatically operated means.

As per one of the embodiment, a liquid supply system is provided with at least one barrier plate mounted inside the hermetically closed storage leaving a narrow opening at the bottom end of the barrier plate;

As per one of the embodiment, a liquid supply system comprises of inter connected network of pipelines connected to the multiple outlets through the delivery pipeline.

As per one of the embodiment, a liquid supply system is provided with a restarting time of the said device to raise or move the liquid that is adjusted by means of introducing time lag into the system based on demand for supply of liquid by the users.

As per one of the embodiment, a liquid supply system is provided with a vertical liquid column with means to prevent air from escaping from the bottom.

As per one of the embodiment, a liquid supply system creates a buffer chamber at a location higher than or near the highest delivery point. This reduces the requirement of pre-pressurizing the tank.

As per one of the embodiment of this invention, the buffer chamber may be formed by extending of the delivery pipeline. The length and diameter of the extended pipe is such that the internal volume created is adequate enough for the system to work efficiently.

Figure A shows schematic view of a liquid supply system according to the embodiments of this invention.

Figure A shows a schematic view of the entire assembly comprising one or more pump (301), the delivery line (305) delivery points (370, 380, . . . ) connected to the outlets (319, 329, 339, . . . ) of the delivery line (305).

The buffer chamber comprises of the barrier chamber(s) (325, 326) and the entry chamber (312) which are connected by barrier plates (315, 316) having narrow bottom opening (313, 323). The entry chamber (312) has a valve (314) attached to it. The barrier chamber (325, 326) volume is larger than the volume of the entry chamber (312). Also a Pressure Release Valves, pressure gauges, gate valves, water hammer arrestors, Non Return Valves, etc. are fitted in a liquid supply system. The said valve (314) can be operated by electric, pneumatic or any other means based on the pressure inside the buffer chamber.

Once the air is “pushed up” it pressurizes the buffer chamber as mentioned above and as shown in the Figure B. The barrier plates (315, 316) permit liquid to enter into the barrier chamber(s) (325, 326) through the bottom openings (313, 323) in barrier plates (315, 326). When the pumps are on and/or when liquid is entering into the buffer chamber, the above mentioned bottom opening (313, 323) is filled with water. Thus even when the liquid enters the barrier chamber, air cannot come out of the barrier chamber and is compressed. The position & number of barrier plates is also designed to ensure adequate and proper air entrapment when—(1) the pumps cut in and smooth liquid inflow, (2) when pumps are off and smooth liquid outflow.

As per the embodiments of the present invention, the barrier plates (315, 316) are connected to the pipeline forming the buffer chamber to separate the entry chamber (312) from the barrier chambers (325, 326). The barrier plates (315, 316) are welded and sealed completely at the top of the extended pipe (or buffer chamber) but with a small opening at the bottom (313,323) to permit liquid flow in. If required one or more barrier plates are placed in series. The barrier plate's creates quazi buffer chambers inside the buffer chamber mentioned above. Beyond the barrier plates (315, 316) the buffer chamber is sealed and this is called barrier chamber (325, 326).

As per the embodiment of the present invention, the one way valve (314) is connected in the buffer chamber adjacent and to the intermediary buffer line (309).

As per the present invention, the intermediary buffer line (309) connects the top most point in the delivery line [305] to the entry chamber [312] of the buffer chamber. The buffer chamber is branched out into two arms with the intermediary buffer line [309] connected in between.

Although all the delivery points are shown as below the buffer chamber, one may take delivery outlets from the main outlets [319, 329, . . . ] or the vertical delivery line [305] to points physically above the buffer chamber. Liquid will get pumped to these points subject to the pressure in the buffer chamber. The buffer chamber and pumps needing that much additional pressure.

As per the embodiment of the present invention one of the methods of air entry in the liquid supply system is achieved by means of displacing the pressurized liquid in the buffer chamber through the means of valve in the buffer chamber. The liquid being productively consumed by the system delivery points.

Figure-B shows the view above the intermediary buffer line [309] of the assembly as shown in the Figure-A.

Once the pump (301) are turned on, the liquid rises up in the delivery line (305) & travels towards many delivery points (370, 380) connected to the main outlets (319, 329, 339). By means of the pump (301), the air in the delivery line (305) & intermediary buffer line (309) is pushed into the buffer chamber to provide additional air (or pressure) inside the closed buffer chamber than its initial capacity.

As per one of the embodiments of the present invention, it provides with improved liquid supply system having intermediary buffer line (309) provided with means to prevent air from escaping out of the bottom. Such means include but are not limited to baffles, barrier plates etc. in the intermediary buffer line (309).

As per the embodiment of the present invention (Figure B) shows that the water has vertically crossed the intermediary buffer line (309) and thereby entered into the entry chamber (312) and barrier chambers (325, 326). The liquid in the small opening [313,323] at the bottom of the barrier plate (315, 316) seals the barrier chambers preventing the air from escaping out, even under intense pressure. The intermediary buffer line (309) and entry chamber (312) are connected by a coupler (310).

As per the embodiment of the present invention each one way valve is peculiarly positioned in the entry because although the one way valve is air tight but it may leak. Thus, if the one way valve is leaking, very little water, if at all will come out of it and will get noticed, but the system continues to function. The valve can get rectified. Air leakage is difficult to notice.

As water rises in the buffer chamber, air is trapped on the top. This trapped air pressurizes the system. Now when the pressure inside the buffer chamber drops due to the consumption of liquid or due to the dissolution of air in the liquid, or for any other reason; one way valve is adjusted in such a manner to replenish the lost air by allowing new air to flow from the atmosphere into the buffer chamber.

Figure C shows various embodiments of buffer chamber, entry chamber and one way valve positions. Accordingly, in Figure C-I, liquid in the intermediary buffer line [not shown in the Figure] enters preferably into the barrier chamber (415) and not the entry chamber (412).

As per another embodiment shown in Figure C-II, liquid enters into the entry chamber (422). The buffer Chamber has barrier plate (420). The one way valve (423) is fixed to the bottom of the barrier chamber (422). Similarly, in Figure-C-III the entry chamber (432), barrier chamber (435), one way valve (433) are shown.

The entry chamber is defined by the space in the buffer chamber formed by the barrier plate opposite to the barrier chamber but having a one way valve attached as shown in Figure C-I & C-II.

A Non Return Valve (NRV) fitted in the reverse direction can also be used in lieu of a Vacuum Relief Valve (VRV) with the same effect. The One way valve may be fitted directly on the entry chamber or through a connecting piping and then taken away at a convenient location. The entry chamber is situated very obviously at a lower position than the bulk of the buffer chamber and having a one way valve connected and fitted to its top portion. The bulk is the barrier chamber, refer figure C-III, IV & V.

In figure C-IV the entry chamber (442), buffer chamber (445), one way valve (443) are shown.

In Figure C V the entry chamber (452), barrier chamber (455), one way valves (453) are shown.

In figure C-VI the entry chamber (462), barrier chamber (465), one way valve (463) are shown.

In figure C-VII, the one way valve is connected to the top of the pressure vessel (475), if one is sure that the VRV (473) will never leak.

In figure C-VIII, the entry chamber (482) & barrier chamber (485) are connected with the entry chamber (482) at the bottom & the intermediary buffer line (481) entering into the barrier chamber (485) directly. The barrier plate (480) protects almost all the air of the buffer chambers from leaking out even if the one way valve (483) leaks.

In Figure C-III to C-VIII, the barrier plate is not used.

The entry chamber is defined by the space in the buffer chamber which is vertically above the intermediary buffer line, nearest to it and where the VRV inlet is connection is fixed, near its topmost position. It is generally below the barrier chamber, else the two are separated by at least one barrier plate. The entry chamber is far smaller than the barrier chamber. When pressure is fully built, liquid may or may not enter the barrier chamber, but liquid will definitely enter the entry chamber, irrespective of the VRV leak.

The layout & design details, such as the gradient in the line of the buffer chamber(s) explained above is such that it facilitates easy drainage/discharge of water and replenishment of air. The extended pipe(s) mentioned above, forming the buffer chamber(s) can be used as a barricade of the structure e.g. on the terrace of the building or on the deck of a ship these can be used as a part or whole of the railing (single tier or multi tier) or as a part of the décor/artifact or conveniently installed as per the layout requirement.

Figures D-I shows application of the invention in the building structure. Figure D-II shows that instead of brick wall hollow air tight parapet line is used, which forms the buffer chamber. Pipelines are connected for taking in and delivery of liquid.

The diameter[s] and length of the delivery pipe line as well as buffer chamber is decided based on the total volume required. One may use multiple rows for each system.

Each of the multi systems can be single or multi level. This kind of a ring main on the top will ensure equal pressure to outlets on all the sides of the building. It can be beautified, covered, decorated as desired.

This pipeline is much lighter [less than ⅙] than a parapet wall, and so reduces the structural load on the building.

Another feature of the present invention is that at a pre determined time or timing the pump start is after a deliberate delay even after the fall in requisite pressure and means such as level sensor can be incorporated to ensure signaling. The time delay (time lag) is calculated and set in the system based on
(1) Level of the liquid in intermediary buffer line/closed storage facility or
(2) Based on the pressure in the closed storage facility or both.

This improved liquid supply system thus gives following advantages to the user:
1. Saves space, reduces cost, and improves efficiency.
2. Tolerates foreign particles in the water.
3. Equal water pressure across the building structure.
4. Reduces structural load, efficient use of material.
5. Reduced pressure on the storage facility.
6. Better and faster response to spurts in demand.
7. Air replenishment does not consume power.
8. Higher utility volume of the storage system.
9. Possibility of use of multiple profiles as buffer chambers.

Thus an improved water supply system which ensures positive air entrapment, easy replenishment & optimum utilization of air, liquid & buffer chamber(s) has been developed.

### EXAMPLES

As per figure A, one sees 3×2=6 main outlets connected to the vertically oriented delivery line. Each main outlet has 4 delivery points. Pumps are connected at the bottom. This system is for an under construction multi storied building. This delivery will go up to the final height of say 240 mts.

In a regular hydro pneumatic system the tanks would be at the bottom and so have to withstand at least 30 kg/cm2 pressure when the final height is reached. The system would operate between say a cutting in pressure of 270 mts and a cutting out pressure of 300 mts. If the tanks were at the bottom they would be seeing a pressure between 300 and 270 mts.

Initially air pressure in the line/buffer chamber is atmosphere pressure. When the pump start, air in the delivery line [305] rises. Beyond point 311, all air of the intermediary buffer line rises up into the buffer chamber. The intermediary buffer line geometry [inside volume] vis a vis the buffer chamber volume is such that when the liquid level reaches point 900, the air that has gone in has already raised the pressure inside the buffer chamber to a requisite level. The intermediary buffer chamber is thus instrumental in raising the buffer chamber pressure even before water entry occurs. This ensures that water flows into the delivery points, during the end of the pump off cycle with pressure.

The system operates with the pumps operating between 270 & 300 mts. The buffer chamber and intermediary buffer line operates between 0 kg/cm2 and 6 kg/cm2 pressure. So more stored water can be used and system has that much more flexibility in supporting spurts in demand. Any spurt in demand is met by the stored & pressurized liquid on the top and the operating pumps at the bottom, so less water has to flow through the pipe from each end [lesser water velocity], lower friction, smoother operation & less power spent.

In a contemporary system also tanks support the pumps during a spurt in demand, when the pumps are on, but all the water flows from one direction only to the concerned outlets.

If the tank size/buffer chamber size in both cases is say 1000 liters then for a 270 to 300 mts range the usable volume is maximum 100 liters. It will be about 300 liters for a 70 to 100 mts. range. The usable volume as per the present invention will be around 750 liters.

As the system continues to operate, some air has got dissolved/lost. When pressure near the pump reaches 300 mts. and system demand is less or zero, pump stop.

Liquid is fed into the system against demand and pressure drops. Liquid level goes down progressively & much before level reaches point 800 pressure in the buffer chamber goes down below 1 kg/cm2. System is designed to not restart the pumps.

The total length of the intermediary buffer line is kept more than 3 mts., if the VRV opening is triggered by say a 0.3 Kg/cm2 pressure difference.

As the system keeps demanding more liquid, the intermediary buffer line exerts a syphonic pressure on the VRV & it is forced to open. Air enters the entry chamber & rises into the buffer chamber, simultaneously liquid continues to flow out into the delivery points by atmospheric pressure plus the vertical height. Pumps are made to restart when water level reaches point (800), factoring a time delay, so liquid flows into the system uninterrupted. The VRV is forced to close.

Air entry is by displacing the pressurized water, which is consumed by the system demand, not wasted. Original air volume is maintained. In case the air is not likely to dissolve in the liquid or for any other reason the air is not required to be replenished, there is no need to provide vacuum relief valve.

The terms ‘buffer chamber’ and ‘closed storage’ are used to convey the same meaning in the complete specification.

Similarly the terms such as ‘intermediary buffer line’ and ‘water column’ are used to convey the same meaning in the complete specification.

I claim:

1. A liquid supply system comprising:
A source of liquid;
at least one storage at an elevation;
supply pipe line connecting the source of liquid to the said storage;
a device to raise/move the liquid from the said source to the said storage;
at least one outlet at or below the level of said storage;
Wherein:
the said storage is hermetically closed and is capable of holding the liquid under air pressure.

2. A liquid supply system claimed in claim 1 above, wherein the said hermetically closed storage is provided with a vacuum relief value allowing atmospheric air to enter into the said hermetically closed storage when the pressure inside the said storage falls below the atmospheric pressure.

3. A liquid supply system claimed in claim 2, wherein the said vacuum relief value is provided near the entry point of the hermetically closed storage.

4. A liquid supply system claimed in claim 1 above, wherein a vertical liquid column is provided between the said supply pipe line and the said hermetically closed storage.

5. A liquid supply system as claimed in claims 2 & 3 above, wherein the said valve is actuated by electrical, mechanical or pneumatically operated means.

6. A liquid supply system as claimed in claim 1 having at least one barrier plate mounted inside the hermetically closed storage leaving a narrow opening at the bottom end of the barrier plate;

7. A liquid supply system as claimed in claim 1, wherein the hermetically closed storage comprises of inter connected network of pipelines connected to the multiple outlets through the delivery pipeline.

8. A liquid supply system as claimed in claim 1, wherein the restarting time of the said device to raise or move the liquid is adjusted by means of introducing time lag into the system based on demand for supply of liquid by the users.

9. A liquid supply system as claimed in claim 4, wherein the said vertical liquid column (309) is provided with means to prevent air from escaping from the bottom.
